(19) United States
(12) Patent Application Publication
(10) Pub. No.: US 2019/0151048 A1
(43) Pub. Date: May 23, 2019

(54) TOOLS FOR USE WITH ORTHODONTIC APPLIANCES AND METHODS FOR USING SUCH TOOLS

(71) Applicant: Ormco Corporation, Orange, CA (US)

(72) Inventors: John Robert Smith, Maitland, FL (US); Dustin R. Tobey, San Dimas, CA (US)

(21) Appl. No.: 16/195,927

(22) Filed: Nov. 20, 2018

Related U.S. Application Data
(60) Provisional application No. 62/589,918, filed on Nov. 22, 2017.

(51) Int. Cl. A61C 7/02; A61C 7/28

(52) U.S. Cl. CPC A61C 7/02; A61C 7/20; A61C 7/28

(57) ABSTRACT

A tool to insert an archwire into an archwire slot of an orthodontic bracket including a handle and a plunger mechanism. A plunger is movable relative to the handle along an operational axis from a retracted to an extended position. An alignment member holds the archwire in the slot. The alignment member includes a pair of tines, each tine including a forked end. The forked end is an open-ended cutout with flats. The plunger includes a tip portion that engages a portion of the orthodontic bracket when the plunger is moved toward the extended position. The plunger mechanism includes a return spring to bias the plunger toward the retracted position. A method of inserting an archwire into an archwire slot using a tool including forcing the archwire into the slot with the tool and moving a movable member with the tool to capture the archwire in the slot.

### CROSS REFERENCE

This application claims the benefit of U.S. Provisional Patent Application Ser. No. 62/589,918 filed on Nov. 22, 2017, the disclosure of which is expressly incorporated by reference herein in its entirety

### TECHNICAL FIELD

The present invention relates generally to the field of orthodontic treatment, and more particularly to orthodontic tools and methods of using those tools during orthodontic treatment.

### BACKGROUND

Orthodontic brackets represent a principal component of one type of corrective orthodontic treatment devoted to improving a patient's occlusion. An orthodontist affixes brackets to the patient's teeth and engages an archwire into a slot of each bracket. The archwire applies corrective forces that coerce the teeth to move toward their orthodontically correct positions. Traditional ligatures, such as small elastomeric O-rings, may be employed to retain the archwire within each bracket slot. Due to difficulties encountered in applying an individual ligature to each bracket, self-ligating orthodontic brackets have been developed that eliminate the need for ligatures by relying on a movable member, such as a clip or a slide, for retaining the archwire within the bracket slot.

Recent developments in self-ligating orthodontic bracket designs include those that are to be attached to the lingual surfaces of a patient's teeth. One of the advantages of lingual brackets is that they are not readily observable. Unlike orthodontic brackets secured to the labial surfaces of the patient's teeth, which become visible when the patient smiles, lingual brackets are hidden from casual observers by the patient's teeth. The patient is thus able to keep their orthodontic treatment hidden from view. While addressing the patient's vanity, lingual self-ligating brackets are not without their unique challenges.

One problem with lingual orthodontic brackets is that archwire changes become more difficult for the clinician. The orthodontist typically changes the archwires per a treatment plan. The shape and size of the archwire may change according to that plan. Orthodontic treatment often begins with a small round archwire and progresses into a rectangular archwire. Consecutively larger rectangular archwires may be used to complete orthodontic treatment. To successfully complete orthodontic treatment, the orthodontist must be able to change the archwire. Ideally, the clinician should be able to easily switch out the archwire. Easy archwire changes facilitate reduced chair time and improve patient comfort. Additionally, it improves the clinician's office throughput thereby increasing income. However, with lingual brackets, archwire changes have occasionally proved difficult.

There are at least two significant challenges when an orthodontist places an archwire on a lingually positioned orthodontic bracket. For one, access to the lingual bracket is problematic as the location produces postural strain on the clinician.

Another problem that complicates archwire changes is that there is often little space between adjacent brackets, particularly those on the lingual surfaces of the anterior teeth. This lack of spacing between adjacent brackets can unduly restrict the clinician's access to the archwire slot and thus makes seating the archwire into full engagement with the archwire slot much more challenging. For example, and with reference to FIG. 1, a commercially available orthodontic bracket that may be used to practice lingual orthodontics is shown. These types of orthodontic brackets are sold by Ormco Corporation under the trademark Alias® and are disclosed in commonly owned U.S. Pat. No. 9,364,298, which is incorporated by reference herein in its entirety.

In FIG. 1, an orthodontic bracket 10 includes a bracket body 12 and a ligating slide 14 (e.g., a movable member) that is slidably coupled with the bracket body 12 by a resilient member 20 (shown best in FIG. 4B). The bracket body 12 includes an archwire slot 16 that receives an archwire 18 (shown in phantom) for applying corrective forces to the teeth. The ligating slide 14 is movable between a closed position (FIG. 1) in which the archwire 18 is retained within the archwire slot 16, and an opened position (FIGS. 3B and 4B) in which the archwire 18 is insertable into the archwire slot 16. When changing the archwire 18, the clinician may initially move the ligating slide 14 to the opened position. The archwire 18 may be removed and a new archwire of different dimensions may be inserted into the archwire slot 16. The ligating slide 14 is then closed to capture the new archwire in the archwire slot 16.

As is shown in FIG. 1, adjacent brackets 10 may be spaced closely together. This is a natural result of the limited lingual surface area available and the relative orientation of adjacent anterior teeth, T. The crowded condition of the brackets 10 leaves only small gaps 42 between adjacent brackets 10. The clinician must be able to manually manipulate the archwire 18 into each of the individual archwire slots 16 despite the limited clearance between adjacent brackets 10 within which to manipulate the archwire 18. By way of example only, the gaps 42 may be significantly less than 3 mm for brackets 10 mounted on the lingual surfaces of the patient's anterior teeth.

In addition to the challenges posed by limited intra-bracket clearance, malocclusions may further complicate those challenges. As is shown in FIG. 1, malocclusions present during initial phases of orthodontic treatment may further reduce the already limited intra-bracket clearance and so further complicate the clinician's difficulties when changing the archwire 18. Adjacent orthodontic brackets are often misaligned due to the malocclusions. That is, adjacent archwire slots may not be aligned on an ideal arch form because of the malocclusions. The clinician may then be required to bend and/or twist (i.e., elastically deform) an archwire to compensate for the misalignment and to fit the archwire within each slot.

Because of the elastic properties of the archwire 18, the archwire 18 will return to its original, undeformed condition and so may pop out of the archwire slot 16 if the clinician removes the forces required to deform the archwire 18 prior to moving the ligating slide 14 to its closed position. Thus, once the clinician inserts the archwire 18 into the slot 16, the clinician may find it necessary to hold the archwire 18 in the slot 16 while simultaneously moving the slide 14 to its closed position. Because of the limited spacing, the orientation of the brackets on the lingual surfaces of the teeth, and the difficulties associated with deforming the archwire while simultaneously moving the slide to the closed position, archwire changes can be particularly difficult. For example, it may require two people to complete. These difficulties may stand in the way of clinical acceptance of lingual orthodontics on a large scale.

Despite the general success of lingual orthodontics, there is a need for tools and methods to improve the ease with which a clinician can change a patient's archwire in lingual orthodontics.

### SUMMARY

The present invention overcomes the foregoing and other shortcomings and drawbacks of tools and methods heretofore known for use in orthodontic treatment. While the invention will be described in connection with certain embodiments, it will be understood that the invention is not limited to these embodiments. On the contrary, the invention includes all alternatives, modifications and equivalents as may be included within the spirit and scope of the present invention.

In accordance with the principles of the present invention, a tool to insert an archwire into an archwire slot of a self-ligating orthodontic bracket comprises a handle, and a plunger mechanism operably coupled to the handle. The plunger mechanism includes a plunger that is movable relative to the handle along an operational axis from a retracted position to an extended position.

In one embodiment, the tool further includes an alignment member proximate the plunger mechanism for holding the archwire in the archwire slot.

In one embodiment, the alignment member extends in a direction that is substantially parallel to the operational axis.

In one embodiment, at least a portion of the alignment member is oriented toward the operational axis.

In one embodiment, the alignment member includes a pair of tines, each tine including a forked end for manipulating the archwire.

In one embodiment, the forked end is an open-ended cutout with at least three flats.

In one embodiment, the plunger includes a tip portion that engages a portion of the self-ligating orthodontic bracket when the plunger is moved toward the extended position.

In one embodiment, the tip portion includes a recess.

In one embodiment, the plunger mechanism includes a return spring that is operable to bias the plunger toward the retracted position when compressed.

In one embodiment, the tool further includes a head operably coupled to one end of the handle.

In one embodiment, the head houses the plunger mechanism.

In one embodiment, the handle includes a bore that encloses at least part of the plunger mechanism and the head closes off the bore.

In one embodiment, the head includes a through-bore which receives part of the plunger.

In one embodiment, the head includes an axial bore that receives the handle and a pair of guide bores that receive the plunger and define the operational axis.

In one embodiment, the plunger mechanism further includes a stop that is coupled to the plunger in the axial bore.

In one embodiment, the handle is an elongate shaft that defines an axis and the operational axis is parallel to the axis of the handle.

In one embodiment, the handle is an elongate shaft that defines an axis and the operational axis is orthogonal to the axis of the handle.

In one embodiment, the handle is an elongate shaft that defines an axis and the operational axis is oriented non-orthogonally to the axis of the handle.

In accordance with the principles of the present invention, a method of inserting an archwire into an archwire slot of a self-ligating orthodontic bracket attached to a tooth using a tool comprises forcing the archwire into the archwire slot with the tool and, simultaneously with forcing, moving a movable member of the self-ligating orthodontic bracket from an open position to a closed position with the tool to capture the archwire in the archwire slot.

In one embodiment, the method further includes torquing the archwire with the tool about its longitudinal axis while forcing the archwire into the archwire slot.

In one embodiment, the self-ligating orthodontic bracket is located on a lingual surface of the tooth.

### BRIEF DESCRIPTION OF THE DRAWINGS

The accompanying drawings, which are incorporated in and constitute a part of this specification, illustrate embodiments of the invention and together with the detailed description given below, explain various aspects of the invention.

FIG. 1 is a perspective view of self-ligating orthodontic brackets attached to lingual surfaces of anterior teeth with an archwire secured to each of the orthodontic brackets.

FIG. 2 is a perspective view of a tool according to one embodiment of the invention.

FIG. 2A is an enlarged elevation view of a portion of the tool shown in FIG. 2.

FIGS. 3A and 3B are elevation end views of the tool shown in FIG. 2 in a retracted position prior to closing of one self-ligating orthodontic bracket shown in FIG. 1.

FIGS. 4A and 4B are side elevation views of the tool shown in FIGS. 3A and 3B, respectively.

FIGS. 5A and 5B are elevation end views of the tool shown in FIG. 2 in an extended position following closing of one of the self-ligating orthodontic brackets shown in FIG. 1.

FIGS. 6A and 6B are side elevation views of the tool shown in FIGS. 5A and 5B, respectively.

FIG. 7 is a perspective view of a tool according to one embodiment of the invention.

FIG. 8 is a perspective view of an end portion of the tool shown in FIG. 7.

FIG. 8A is an enlarged perspective view of a portion of the tool shown in FIG. 8.

FIG. 9 is a cross-sectional view of the tool shown in FIG. 7 taken along section line 9-9.

FIG. 10 is a cross-sectional view of the tool shown in FIG. 7 taken along section line 9-9 during operation of the tool.

FIG. 11 is an enlarged view of an operational end of the tool in the encircled area 11 shown in FIG. 10.

FIGS. 12 and 13 are enlarged views similar to that shown in FIG. 11 during use of the tool on an orthodontic bracket.

### DETAILED DESCRIPTION

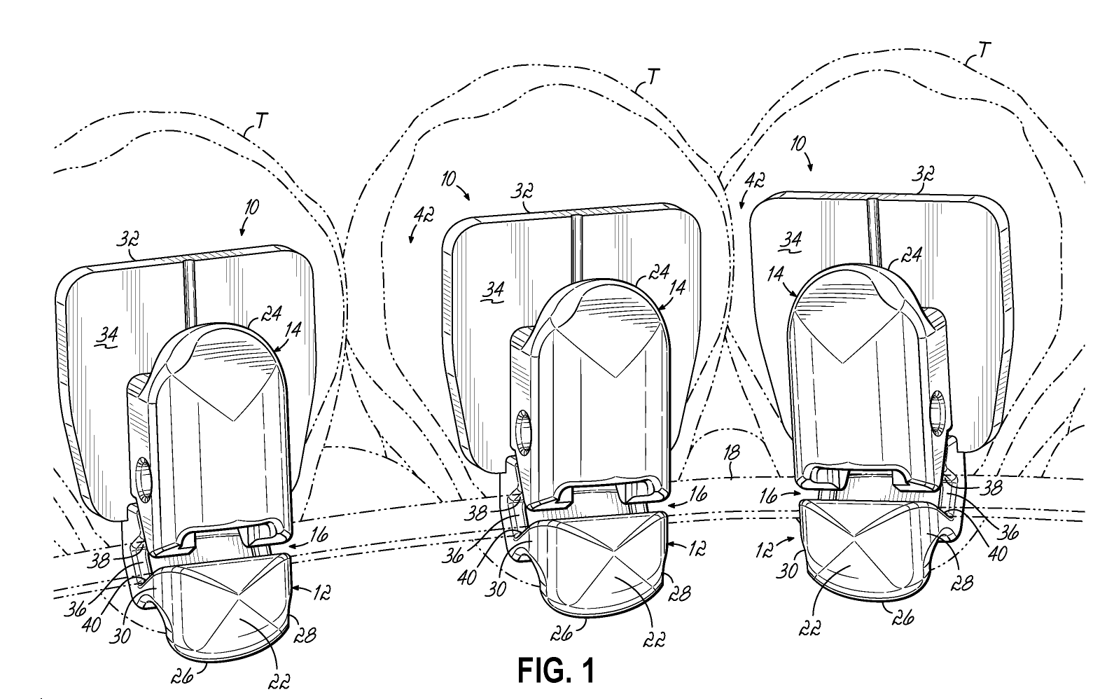

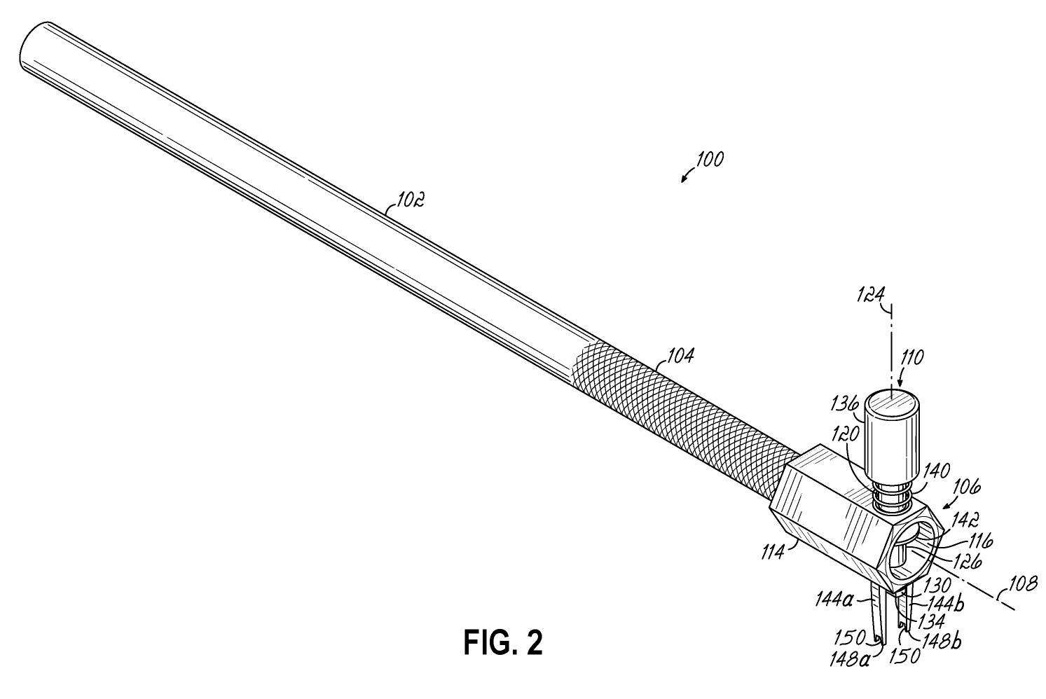

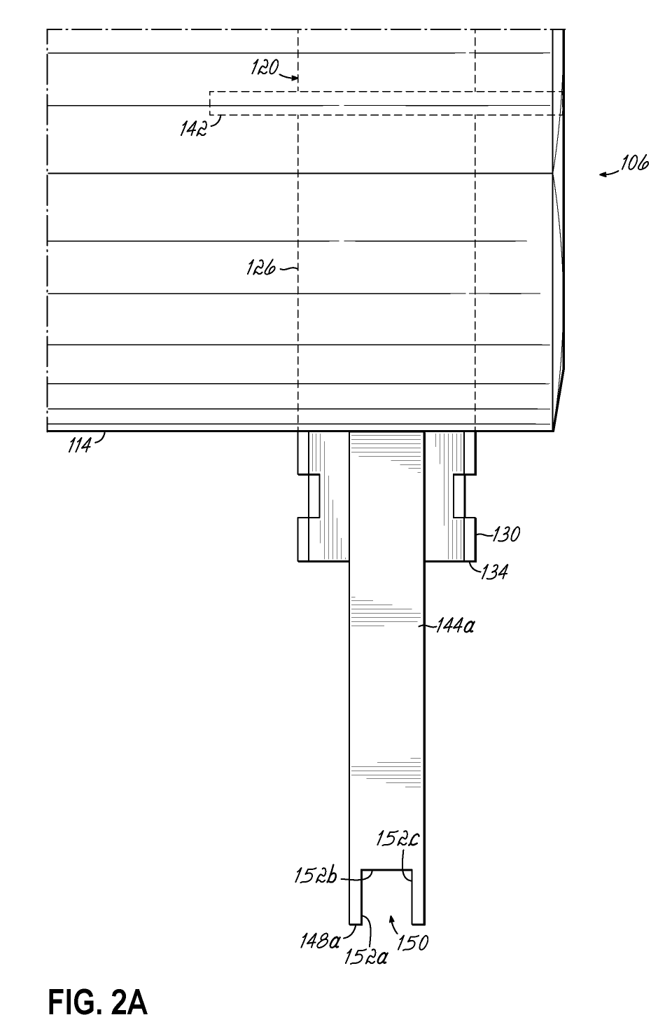

To these and other ends, and referring to FIGS. 1 and 2, a clinician may use a tool 100 (FIG. 2) to facilitate archwire changes on a self-ligating orthodontic bracket secured to a lingual surface of a patient's tooth. By way of example only, the tool 100 may enable the clinician to more easily change the archwire 18 of the self-ligating orthodontic bracket 10. As shown in FIG. 1, the self-ligating orthodontic bracket 10 includes the bracket body 12 that defines the archwire slot 16, and the slide 14 that is movable relative to the archwire slot 16. The self-ligating orthodontic bracket 10 is shown mounted on the lingual surface of a tooth T carried on the patient's lower jaw. The bracket body 12 has a lingual side 22, an occlusal side 24, a gingival side 26, a mesial side 28, a distal side 30, and a labial side 32. The labial side 32 may include a pad 34 that is coupled to the bracket body 12 as a separate piece or may be integrally formed with the bracket body 12. As shown, the pad 34 may be shaped to fit on the lingual surface of tooth T. The bracket body 12 defines the archwire slot 16 having a base surface 36 and slot surfaces 38, 40 extending lingually from the base surface 36.

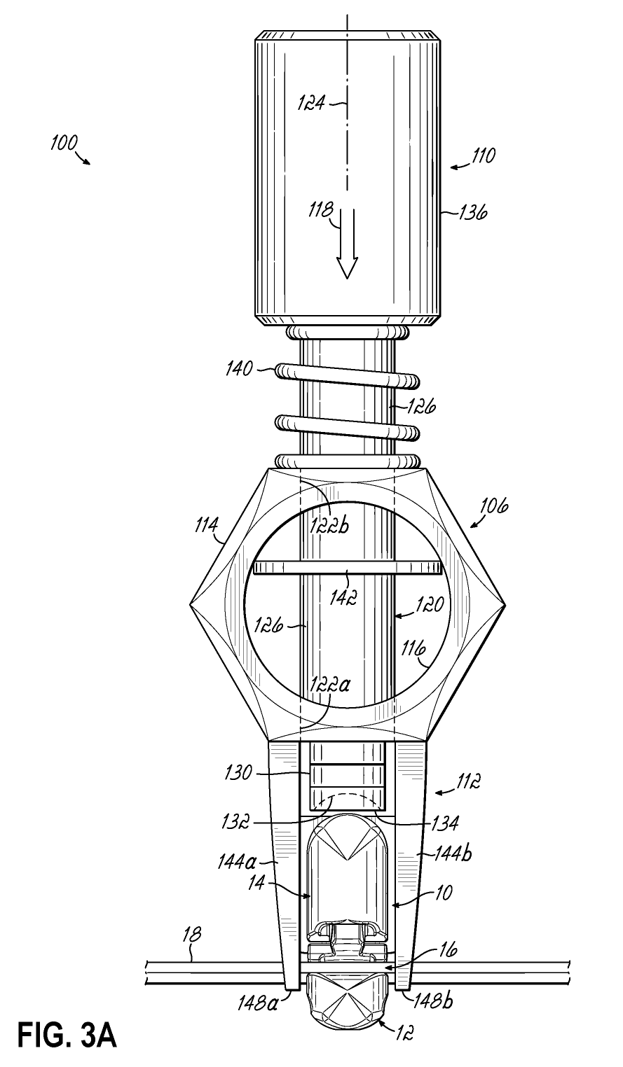

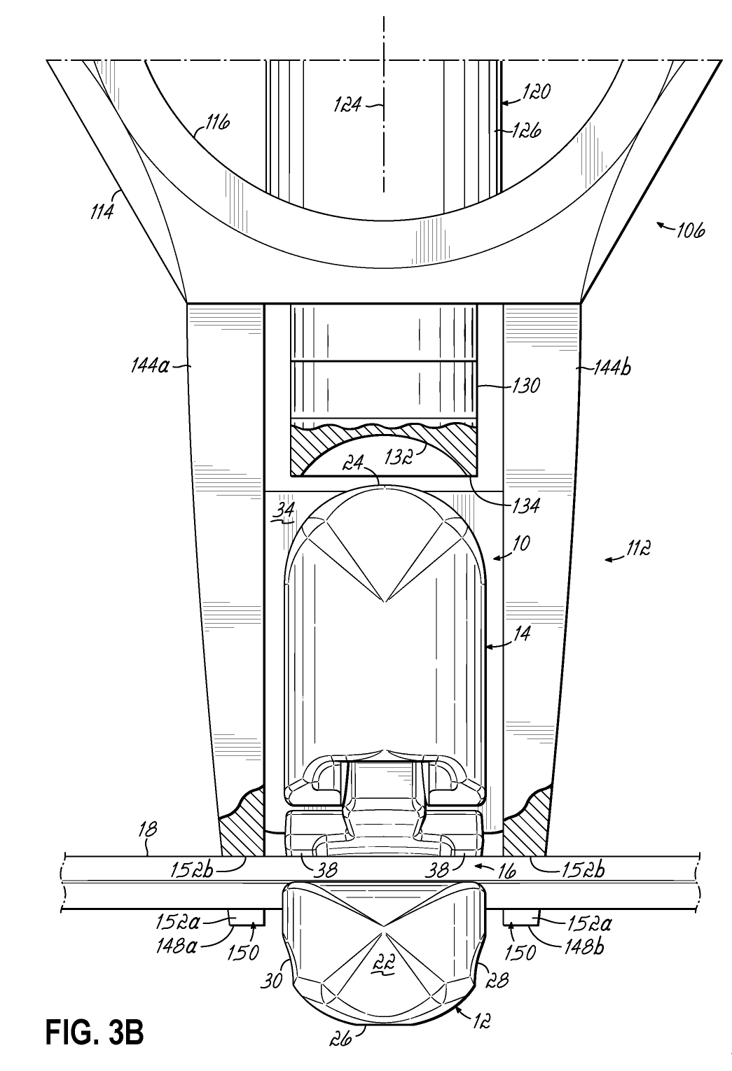

With reference to FIGS. 2, 3A, and 3B, an exemplary embodiment of the tool 100 includes a handle 102 in the form of an elongate shaft that defines an axis 108. During use, the clinician may grasp the handle 102, which may include a knurled area 104 or other roughened surface that enables the clinician to more firmly manipulate the tool 100 as is described below. A head 106 extends from the handle 102 at one end by which the clinician may operate the tool 100 to manipulate the slide 14 and the archwire 18. In that regard, the tool 100 includes a plunger mechanism 110 and an alignment member 112 for simultaneously moving the slide 14 and the archwire 18. The tool 100 may be made of sterilizable material. In that regard, the entire tool 100 or a portion thereof may be made of a hardenable stainless steel. Advantageously, the clinician may use one hand to operate the tool 100 to both seat the archwire 18 in the archwire slot 16 and close the ligating slide 14.

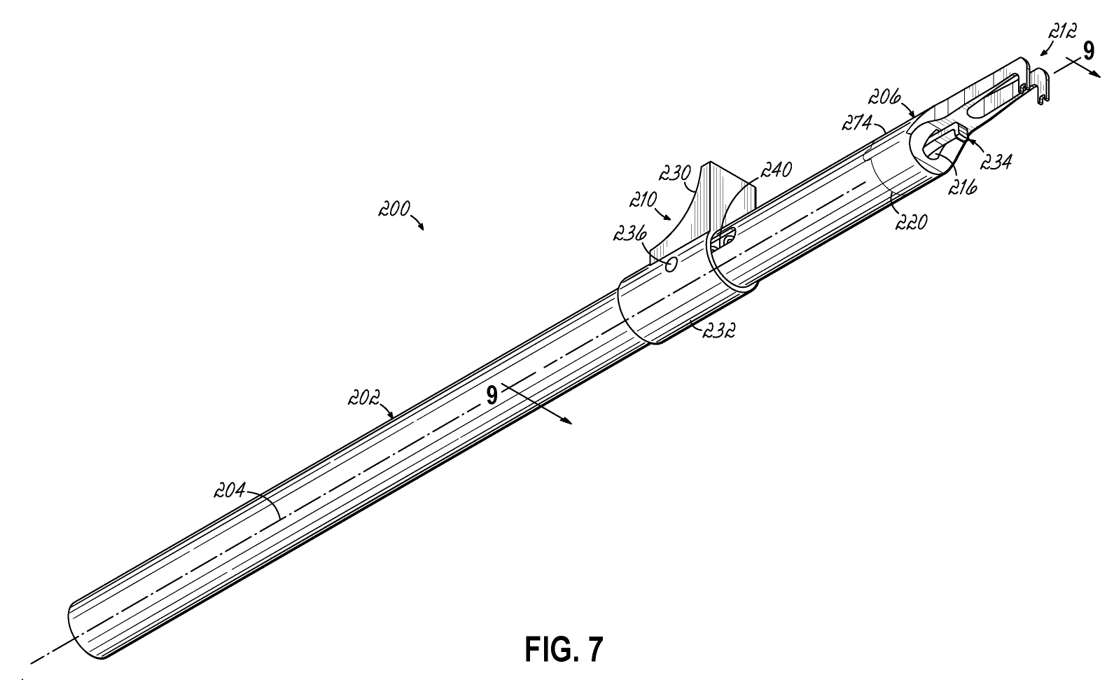

In the exemplary tool 100, the head 106 is a hollow, hexagon-shaped member 114. An axial bore 116 in the hexagon-shaped member 114 may extend part way through or all of the way through the hexagon-shaped member 114 and receives the handle 102 by which the handle 102 is coupled to the head 106. The head 106 may be aligned with the axis 108 and welded or soldered to the handle 102. It will be appreciated that embodiments of the present invention are not limited to the configuration of the handle 102 and the head 106 shown. For example, the handle 102 and the head 106 may be a single unitary piece (such the embodiment shown beginning at FIG. 7 and described below) or separate differently shaped components connected by other means.

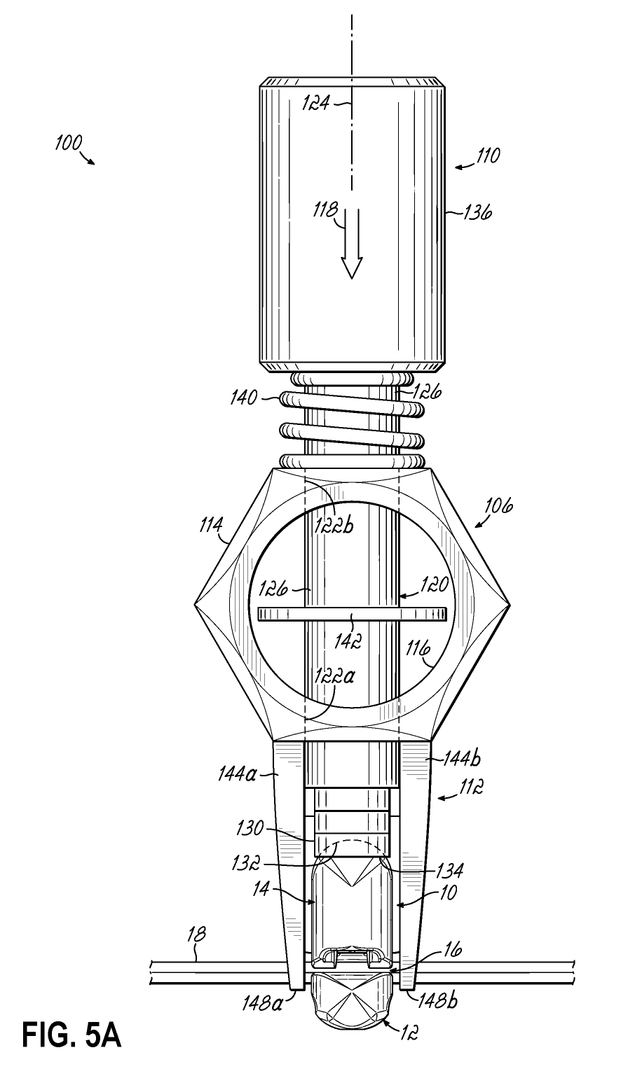

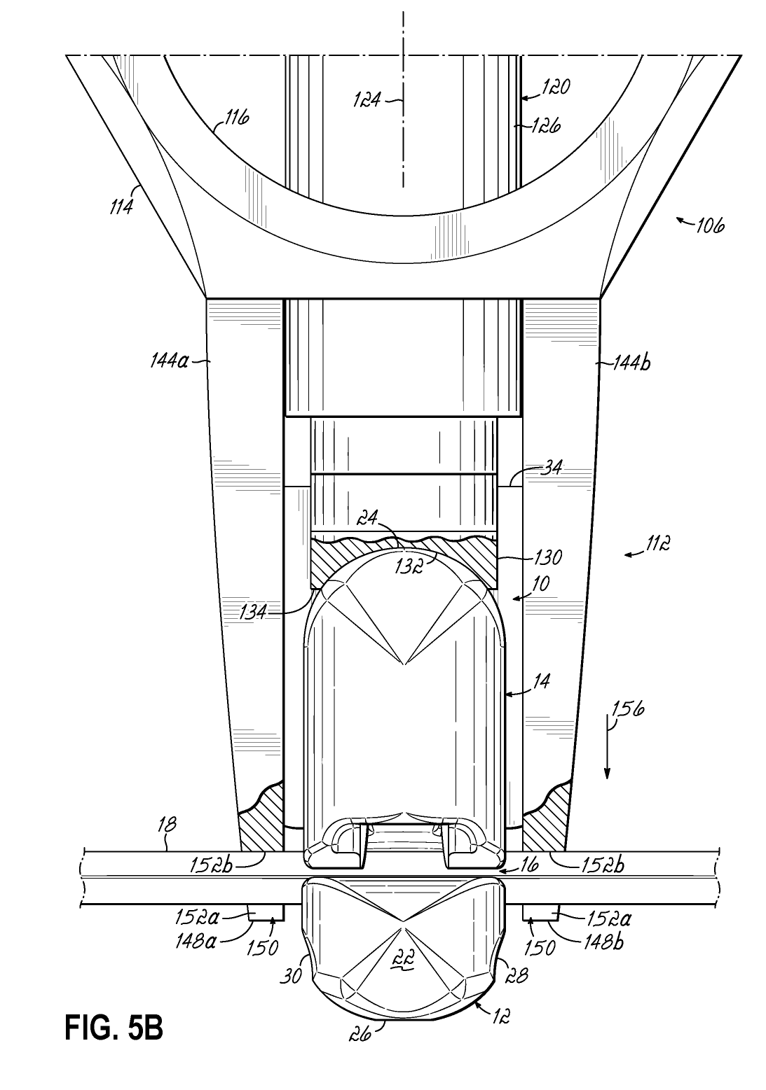

With reference to FIGS. 2 and 3A, in one embodiment, the plunger mechanism 110 includes a plunger 120 that is movable within a pair of guide bores 122a and 122b (shown in hidden line in FIG. 3A) in the hexagon-shaped member 114. The bores 122a and 122b define an operational axis 124 along which the plunger 120 is movable as is indicated by arrow 118 in FIG. 3A from a retracted position shown in FIG. 3A to an extended position shown in FIG. 5A. While the operational axis 124 is shown to be generally perpendicular to the axis 108, embodiments of the invention are not limited to the generally perpendicular orientation shown. By way of example only, the relative orientation between axes 108 and 124 may be acute (i.e., less than) 90° or obtuse (i.e., greater than 90°) and may depend upon the orientation of the orthodontic bracket 10 attached to the patient's tooth, particularly the direction of movement for the slide 14 relative to the base surface 36 of the archwire slot 16. By way of further example, the axis 108 may be aligned with the axis 124. In this configuration, the tool 100 may have a ballpoint pen-like appearance, and as an additional example, the axis 124 may be adjustable relative to the axis 108.

A shaft 126 of the plunger 120 may extend through each of the opposed guide bores 122a and 122b. A tip portion 130 extends from the shaft 126 into a position that cooperates with the alignment member 112 and is positioned to contact the ligating slide 14 of the self-ligating orthodontic bracket 10 when the clinician operates the plunger mechanism 110. A recess 132 forms a portion of a leading surface 134 of the tip portion 130 in a direction substantially parallel to the axis 124 (i.e., within ±5°) and may be shaped to uniformly contact the ligating slide 14 (shown best in FIG. 5B). The shape of the recess 132 may vary according to the shape of the ligating slide 14. In that regard, the recess 132 may engage the ligating slide 14 in such a way that the ligating slide 14 slides along the leading surface 134. Advantageously, the recess 132 may help align the force generated by forcible movement of the plunger 120 with the sliding direction of the ligating slide 14. In that regard, the shape of the recess 132 may allow the ligating slide 14 to slide along the leading surface 134 and so automatically reorient the ligating slide 14 to the direction of movement of the plunger 120. As is described below, this may prevent the ligating slide 14 from being pushed into an inoperable position in which it becomes immovable (i.e., it gets stuck) relative to the bracket body 12.

With reference to the exemplary embodiment shown in FIG. 3A, a head 136 may be coupled to the shaft 126 at the other end of the plunger 120 from the tip portion 130. The head 136 may simply be an enlarged cylinder soldered to the end of the shaft 126 opposite the tip portion 130. A return spring 140 may bear against the head 136 and the hexagon-shaped member 114 and is compressed during operation of the plunger mechanism 110. Upon release of the plunger 120, the compressed return spring 140 may forcibly return the plunger 120 to its retracted position shown in FIG. 3A. In one embodiment, the return spring 140 may bias the plunger toward the retracted position. A stop 142 may be secured to the shaft 126, such as within the bore 116, and may prevent inadvertent disassembly of the tool 100. In that regard, the stop 142 may limit the movement of the plunger 120 in one or both directions. That is, the stop 142 may limit a stroke distance of the plunger 120 during operation of the plunger mechanism 110 from the retracted position shown in FIG. 3A to the extended position shown in FIG. 5A. The stop 142 may bottom out against the hexagon-shaped member 114 before the return spring 140 is fully compressed. On return of the plunger 120 to the retracted position, the stop 142 may contact the hexagon-shaped member 114 before the return spring 140 is fully extended. In this configuration, the return spring 140 may be slightly biased when the plunger 120 is in the retracted position. While FIG. 3A depicts a hexagon-shaped member 114 and a cylindrical bore 116 to accommodate the plunger 120 and the stop 142, the head 114 may have other shapes and the axial bore 116 may have other configurations. For example, the head 114 may be integrally formed with the handle 102 so as to have the same general configuration as the handle 102, and the bore 116 may have either a square or rectangular configuration. There may be some advantage to changing the shapes of the head 114 and/or the bore 116, for example, to reduce the size and weight of the tool 100 and/or enhance the effectiveness of the plunger 120 and the tip portion 130 relative to the ligating slide 14.

As shown in FIGS. 2, 2A, 3A, 4A, and 4B, in one embodiment, the alignment member 112 includes a pair of tines 144a and 144b that engage the archwire 18 during an archwire change. The tines 144a and 144b extend from the head 106 in the direction of the operational axis 124 to a distance sufficient to engage the archwire 18 in the archwire slot 16. By way of example only, and without limitation, the tines 144a, 144b may be substantially parallel (i.e., within ±5°) to the operational axis 124 along their length. As shown in FIG. 2A, each tine 144a, 144b may extend at a substantially perpendicular angle from the head 106 (i.e., perpendicular to the axis 108) and be aligned with the axis 124. Embodiments of the invention are not limited to a parallel alignment of the tines 144a, 144b with the axis 124 and are not limited to a perpendicular alignment of the tines 144a, 144b with the axis 108. The tines 144a, 144b may be non-orthogonally oriented to both the axis 108 and/or the axis 124. The length of the tines 144a and 144b may be sufficient to provide clearance between the tip portion 130 and the ligating slide 14 when the ligating slide 14 is in the opened position and the plunger 120 is in the retracted position.

As shown in FIGS. 2A and 3A, the tines 144a and 144b may be positioned proximate opposing edges of the guide bore 122a and may straddle the self-ligating orthodontic bracket 10 during use of the tool 100. The tines 144a and 144b are sized to fit within the gap 42 (FIG. 1) between adjacent brackets on the patient's lower anterior teeth. In that regard, the spacing between the tines 144a and 144b may be sufficient to receive the ligating slide 14 but provide only a minimal gap between the ligating slide 14 and each tine 144a and 144b. By way of example only and not limitation, the tines 144a and 144b may be spaced apart by about 0.5 mm larger than the mesial-distal width of the bracket body 12. It will be appreciated that the gap between the slide 14 and each tine 144a and 144b is sufficient to prevent the ligating slide 14 from being torqued into an inoperable position so that the slide 14 becomes mechanically bound against the bracket body 12. In other words, during movement of the ligating slide 14 from the opened position to the closed position, it may slidably contact one or both of the tines 144a and 144b and so be guided by the tines 144a and 144b during closing.

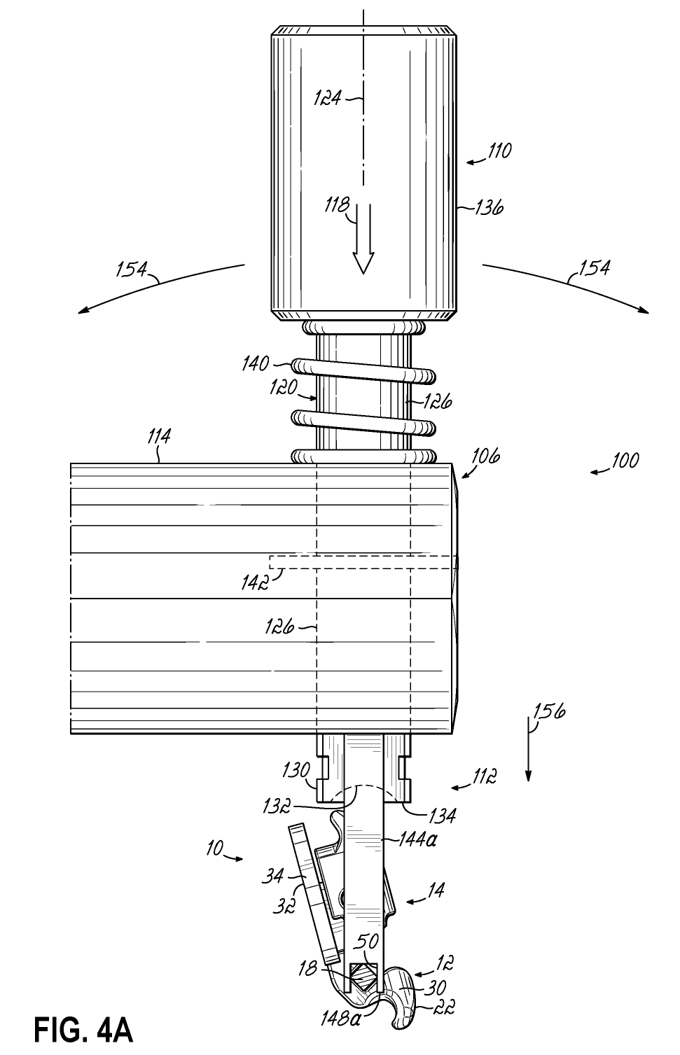

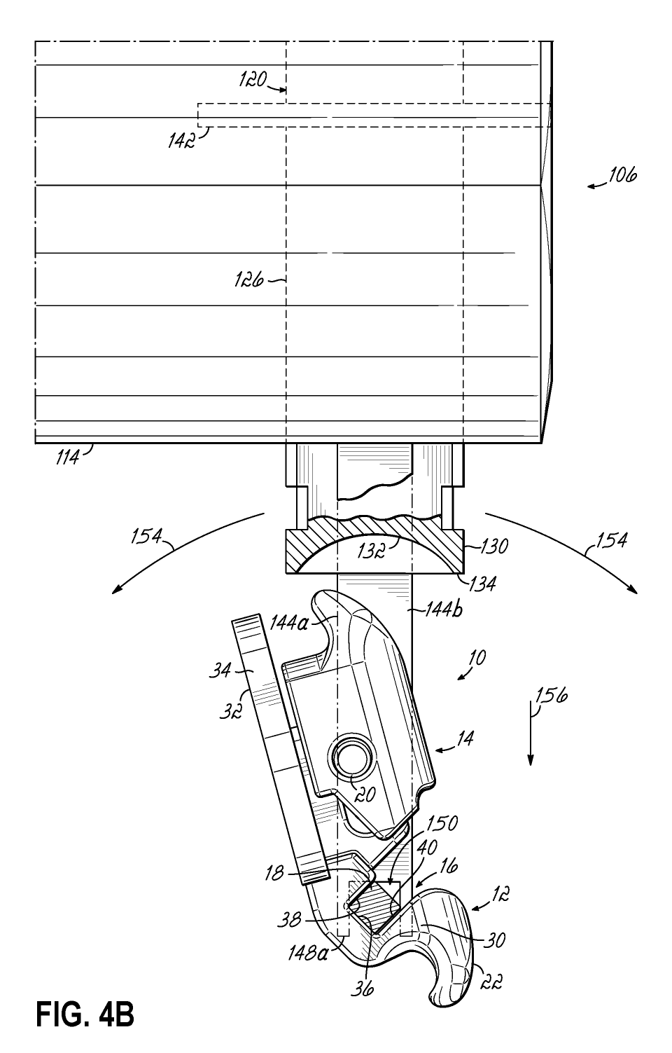

Each tine 144a and 144b may generally taper from its location of attachment on the head 106 to a tip end, which is generally configured to engage the archwire 18. To that end, each tine 144a and 144b has a forked end 148a, 148b that may engage a rectangular archwire (e.g., a square archwire) so that the clinician may apply torque to the archwire 18 by manipulating the handle 102. By way of example only, the forked ends 148a, 148b may be defined by an open-ended cutout 150. In the exemplary embodiment, three flats 152a, 152b, and 152c (shown best in FIG. 2A) that intersect at corners define the exemplary cutout 150. While not being limited to the configuration shown, the cutouts 150 may have a square or rectangular configuration. This wrench-like configuration may be slid over the archwire 18 so that one or more of the flats 152a, 152b, and 152c may be proximate one of the sides of the archwire 18. The clinician may then rotate the tool 100 about the contact point between the cutout 150 and the archwire 18 (as indicated by arrows 154 in FIGS. 4A and 4B) to apply torque to the archwire 18, if necessary. Rotating the tool 100 may cause one or more of the flats 152a-c of one or both forked ends 148a and 148b to engage a flat on a rectangular archwire. The engagement between the flats 152a-c and flats on the rectangular archwire allows the clinician to rotate a portion of the archwire 18 about its longitudinal axis to create an active couple, essentially twisting a localized region of the archwire 18 so that the localized region fits within the archwire slot 16. By way of example only, the cutout 150 may be sized to receive a square archwire of various sizes, for example, an archwire measuring about 0.016 inch square or one measuring 0.018 inch square, where “about” refers to within normal machining tolerances. As shown, a square archwire may fit diagonally between opposing flats 152a and 152c. The cutouts 150 may still engage the archwire 18 during rotation of the tool 100 according to arrow 154. Alternatively, a clinician may use a separate tool (not shown) to torque the archwire while the clinician uses the tool 100 to guide the archwire 18 into the archwire slot 16 and move the ligating slide 14 to its closed position. The tines 144a and 144b may be removable and replaced with tines 144a, 144b having a different configuration of cutout 150. Advantageously, removable tines 144a, 144b of different sizes may make having numerous tools 100 unnecessary. The forked end 148a, 148b may be a hardened stainless steel. Although not shown, the forked ends 148a and 148b may engage a round archwire and facilitate placement of the round archwire in the archwire slot 16.

In addition to applying torque to a rectangular archwire, the clinician may also or alternatively forcibly seat the archwire 18 within the archwire slot 16 (as indicated by arrowed 156 in FIGS. 4A and 4B). This may include forcing the archwire 18 against one or more of the surfaces 36, 38, 40 of the archwire slot 16. With the archwire 18 properly torqued and seated within the archwire slot 16, the clinician may then operate the plunger mechanism 110 to close the ligating slide 14.

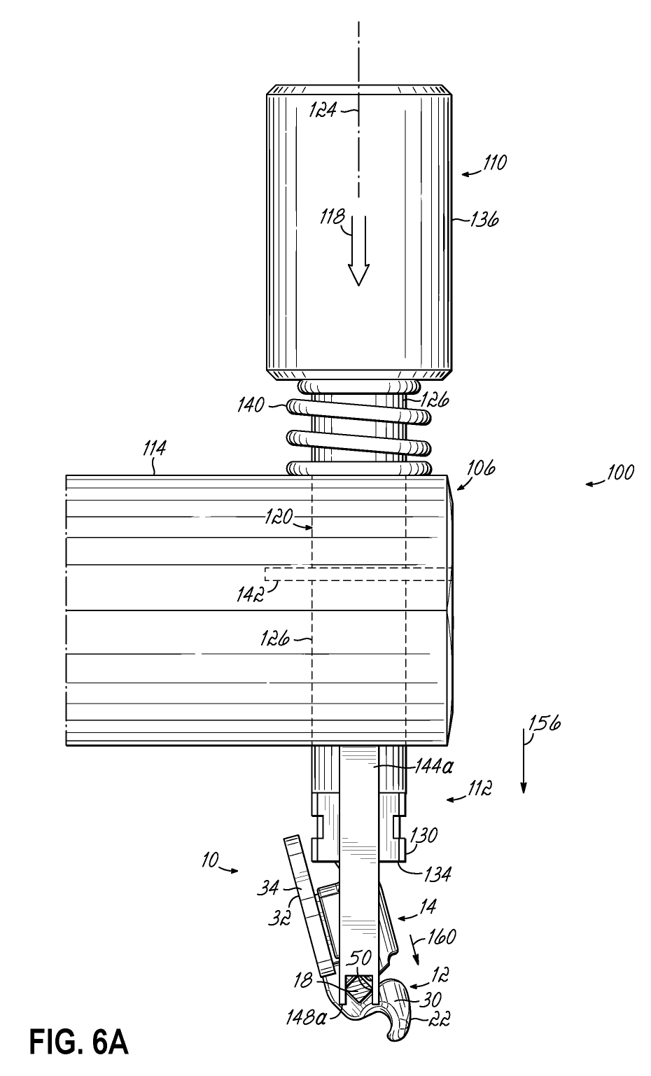

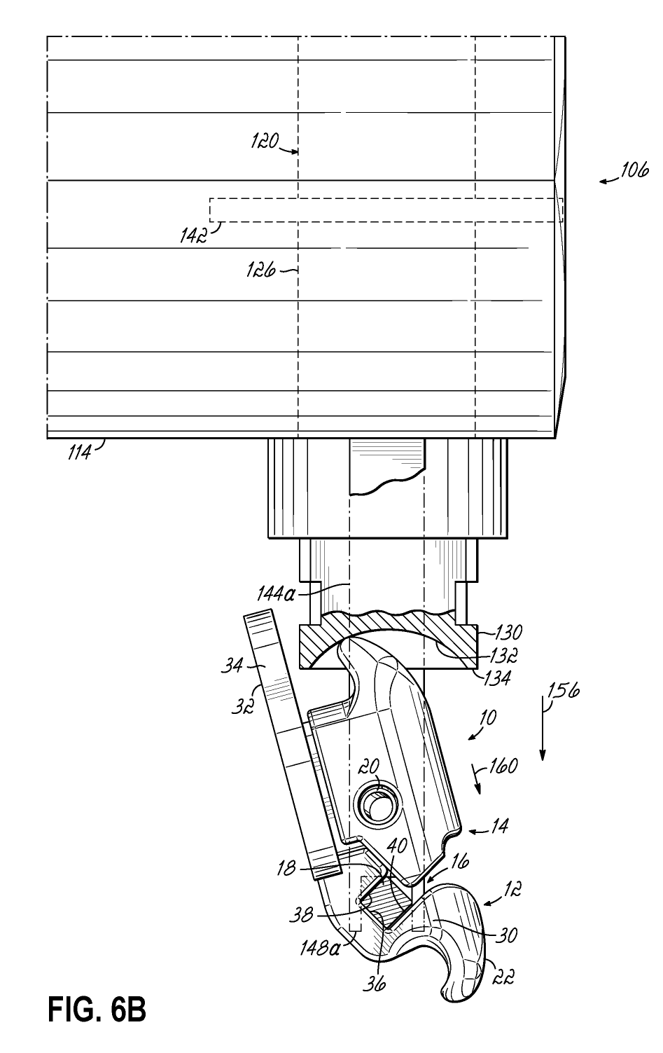

To that end and with reference to FIGS. 5A, 5B, 6A, and 6B, the clinician may operate the plunger mechanism 110 to engage the tip portion 130 of the shaft 126 with the ligating slide 14. This is generally indicated by the arrow 118 in FIGS. 5A and 6A. As the clinician presses the plunger mechanism 110 such as with their finger or thumb, the clinician moves the plunger 120 from a retracted position shown in FIGS. 3A-4B toward the ligating slide 14. Further movement causes the recess 132 to engage the ligating slide 14 and the clinician is able to push the ligating slide 14 in the direction generally indicated by arrow 160 in FIG. 6A toward the closed position for the ligating slide. While the plunger 120 may travel along the axis 124, the ligating slide 14 may be pushed in a direction that does not coincide with the axis 124, as shown. In the exemplary embodiment shown, there is an acute angle formed between axis 124 and the direction of slide translation 160. The force applied to the plunger mechanism 110 may be sufficient to overcome any bias associated with a resilient member 20 (shown best in FIG. 4B) and thus moves the ligating slide 14 to its closed position. Once in the closed position, the ligating slide 14 captures the archwire 18 in the archwire slot 16, which is generally shown in FIG. 6B. Advantageously, the clinician may operate the tool 100 with one hand to rotate and seat the archwire 18 in the archwire slot 16 and then move the ligating slide 14 to the closed position.

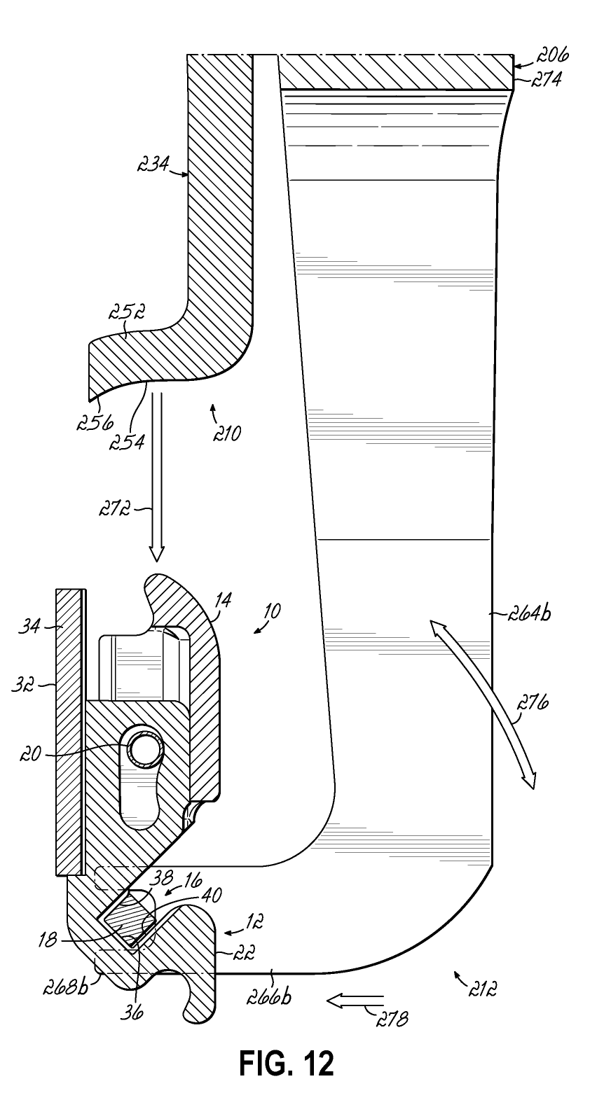

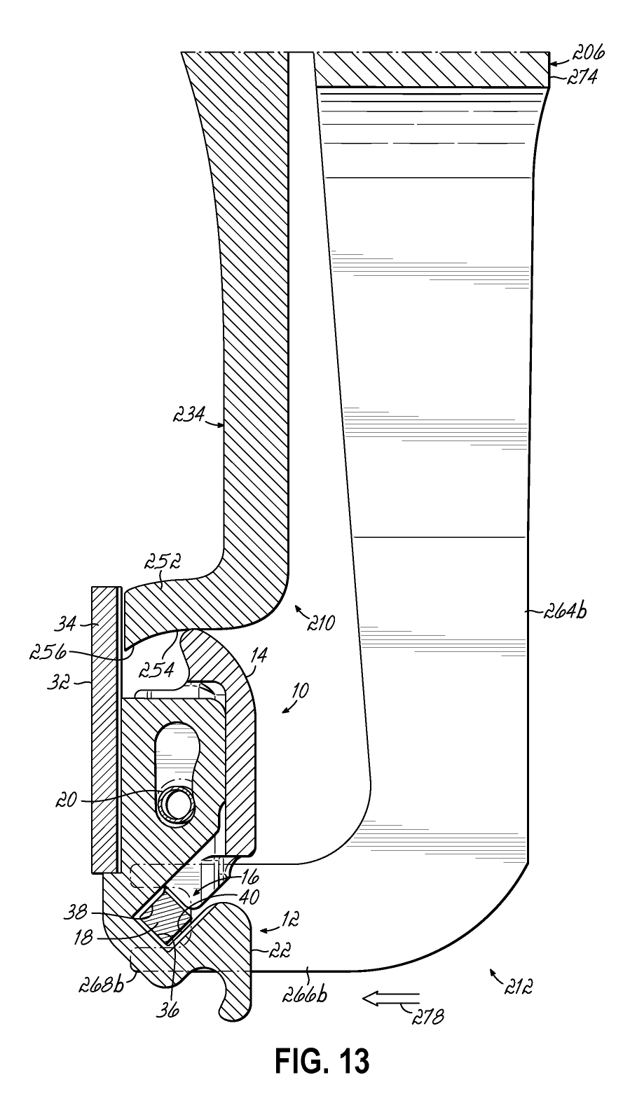

Another exemplary embodiment of a tool 200 is shown in FIGS. 7-13. With reference to FIG. 7, the tool 200 includes a handle 202 in the form of an elongate shaft that defines an axis 204. A head 206 is positioned at one end of the handle 202 and is for cooperating with an orthodontic bracket and an archwire (shown in FIG. 1) in a similar manner to that described above with regard to the tool 100. The tool 200 includes a plunger mechanism 210 and an alignment member 212 by which the clinician may manipulate the orthodontic bracket while simultaneously orienting an archwire in an orthodontic bracket, respectively. To that end, during use, the clinician may grasp the handle 202 and position the alignment member 212 into cooperation with an orthodontic bracket positioned on a lingual surface of a patient's tooth. Operation of the plunger mechanism 210 closes the ligating slide over the archwire while it is held in place with the alignment member 212. Similar to the plunger mechanism 110 of the tool 100, the plunger mechanism 210 enables the clinician to move the slide 14 to the closed position while alignment member 212 enables the clinician to simultaneously hold, and if necessary torque, the archwire 18 into the archwire slot 16 of the orthodontic bracket 10 (shown in FIGS. 12 and 13, described below). The clinician may perform these simultaneous actions with a single hand through the use of the tool 200.

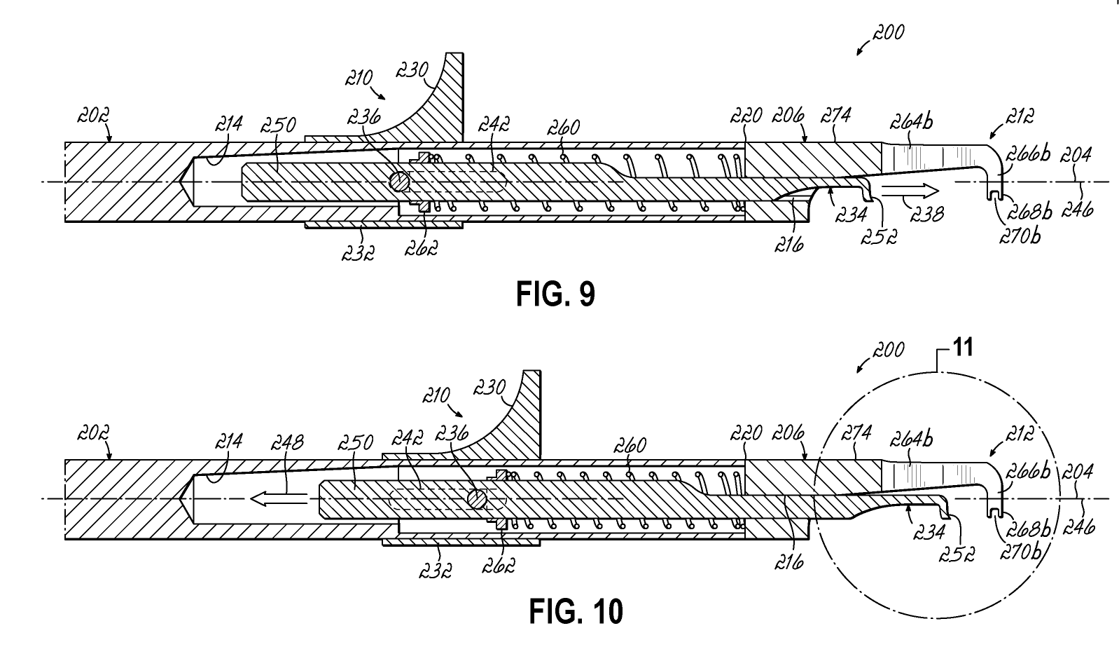

To that end, as shown in FIGS. 9 and 10, the handle 202 includes a blind bore 214 within which the plunger mechanism 210 is at least partially enclosed. The head 206 essentially caps the blind bore 214 and extends from the handle 202 in a direction that is essentially parallel with the axis 204. The head 206 is unlike the head 106 of the tool 100 shown in FIG. 2. In that regard, an axis of the head 206 coincides with the axis 204. The handle 202 and the head 206 are arranged in line and so form an elongate member that is much closer to being a circular cylinder from end to end than the tool 100. The in-line arrangement may be advantageous, because the load on the orthodontic bracket is directed more perpendicular to the tooth surface and, as a consequence, use of the tool 200 is less likely to apply shear forces to the bond between the tooth and the bracket. This is described below in conjunction with FIGS. 12 and 13.

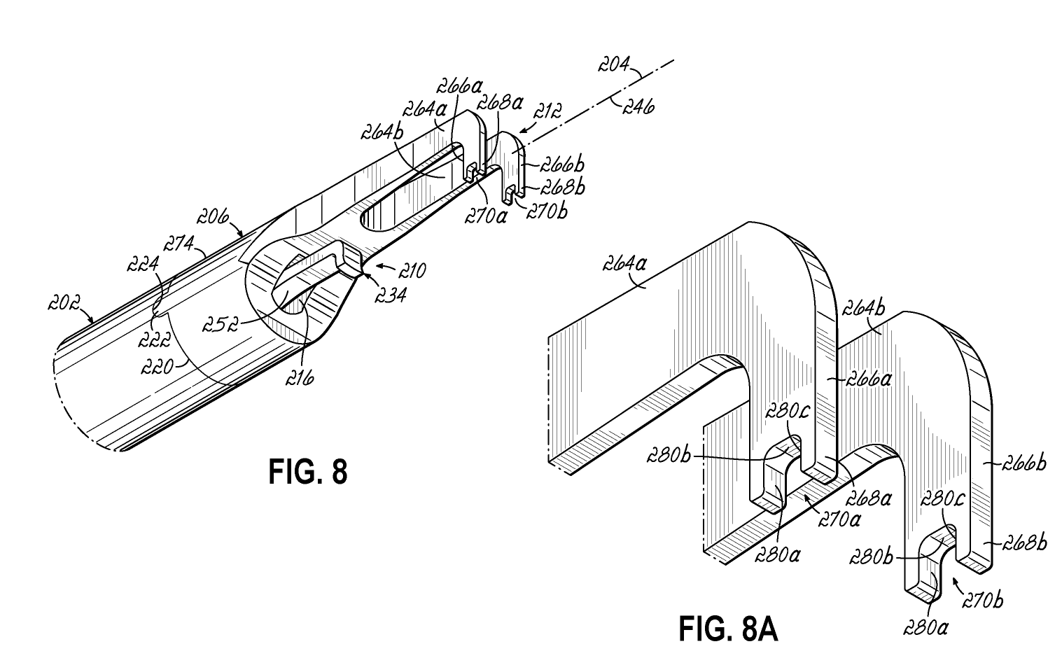

With reference to FIGS. 7 and 8, the head 206 includes a cap portion 274 which defines a through-bore 216 that slidably receives a portion of the plunger mechanism 210 and from which the alignment member 212 extends. As shown, the outer surface of the head 206, for example the cap portion 274, may match the outer surface of the handle 202 so that a joint 220 between the head 206 and the handle 202 produces a smooth and continuous transition between the outer surfaces of the handle 202 and the head 206. Embodiments of the present invention are not limited to the uniformity between the outer surfaces of the handle 202 and the outer surfaces of the head 206. The joint 220, however, may be nonuniform in a plane perpendicular to the axis 204 and may be configured to prevent relative rotation between the head 206 and the handle 202. In the exemplary embodiment, the head portion of the joint 220 may include a tab 222 and the handle portion of the joint 220 may include a matching recess 224. The joint 220 is formed by fitting the tab 222 with the recess 224 to bring the head 206 into contact with the handle 202. It will be appreciated that this joint configuration prevents relative rotation between the head 206 and the handle 202 about the axis 204. However, embodiments of the invention are not limited to the joint configuration shown, as other joint configurations may prevent relative rotation.

With reference to FIGS. 7-10, the plunger mechanism 210 includes a grip 230 that is movable relative to the handle 202. The grip 230 may include a collar 232 that is generally formed to cooperate with the handle 202 and slide relative to the outer surface of the handle 202 during operation of the plunger mechanism 210. The grip 230 may be shaped to cooperate with the clinician's thumb or a finger. The clinician may then grasp the handle 202 with one hand and move the grip 230 in the direction of the arrow 238 shown in FIG. 9 with their thumb on that one hand. The tool 200 may be made of sterilizable material. In that regard, the entire tool 200 or a portion thereof may be made of a hardenable stainless steel.

The plunger mechanism 210 further includes a plunger 234 that is coupled to the grip 230 via a pin 236. The pin 236 is inserted into a through-bore in the collar 232, and passes through a slot 240 in the handle 202 and through the plunger 234. The pin 236 may pass through an opposing slot 242 and engage a through bore in the collar 232 of the grip 230 at a second location. Thus, movement of the grip 230 in the direction of arrow 238 in FIG. 9 moves the plunger 234 in the same direction within the bore 214 and generally parallel to axis 204. By contrast with the tool 100, in which the operational axis 124 is transverse to the axis 108, the axis 204 may be parallel to an operational axis 246 of the plunger mechanism 210. The plunger 234 reciprocates between a retracted position and an extended position to define the operational axis 246. By way of example, in one embodiment, the operational axis 246 coincides with the axis 204 though the operational axis 246 may be offset but parallel to the axis 204. In the embodiment shown, the slots 240, 242 may limit a stroke distance of the plunger 234 along the operational axis 246. By way of example only, the stroke distance may be equal to the length of the slots 240, 242.

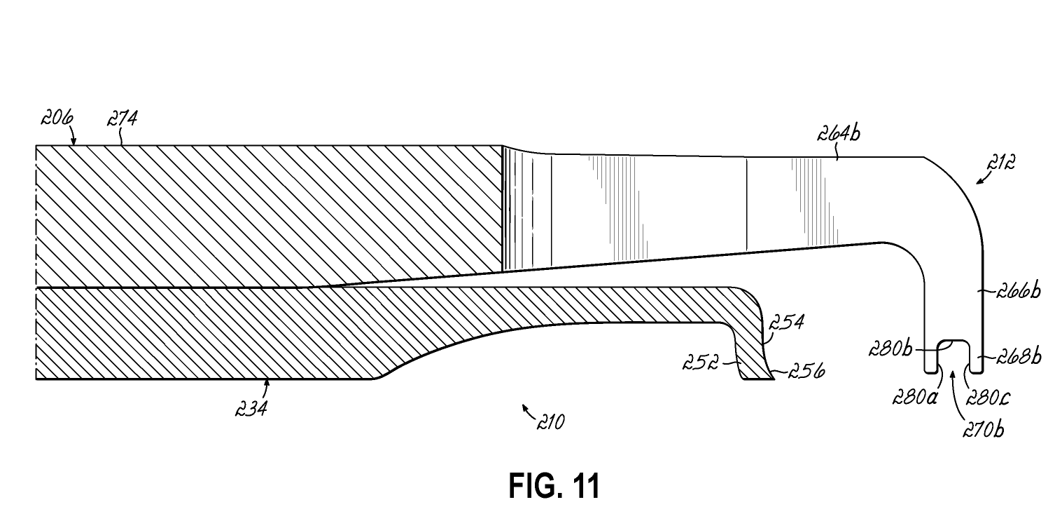

With reference to FIGS. 9 and 10, a shaft 250 of the plunger 234 is at least partially enclosed in the bore 214 of the handle 202. A tip portion 252 extends from the shaft 250 into a position that cooperates with the alignment member 212 and is positioned to contact the ligating slide 14 of the self-ligating orthodontic bracket 10 when the clinician operates the plunger mechanism 210 (as is shown in FIG. 13). The tip portion 252 projects from the through-bore 216 of the head 206 and includes a scoop-like depression 254 that forms a portion of a leading surface 256 of the tip portion 252 (shown best in FIG. 11). The scoop-like depression 254 may be formed by slightly bending the tip portion 252. The scoop-like depression 254 is shaped to uniformly contact the ligating slide 14 (shown best in FIGS. 12 and 13). The shape of the depression 254 may vary according to the shape of the ligating slide 14. In that regard, the depression 254 may engage the ligating slide 14 in such a way that the ligating slide 14 slides along the leading surface 256. Advantageously, the depression 254 may help align the force generated by forcible movement of the plunger 234 with the sliding direction of the ligating slide 14. In that regard, the shape of the depression 254 may allow the ligating slide 14 to slide along the leading surface 256 and so automatically reorient the ligating slide 14 to the direction of movement of the plunger 234. As is described below, this may prevent the ligating slide 14 from being pushed into an inoperable position in which it becomes immovable (i.e., it gets stuck) relative to the bracket body 12.

With reference to FIGS. 9 and 10, the plunger mechanism 210 includes a return spring 260 that is contained in the bore 214 and is captured between the head 206 and a collar 262 that is secured to the plunger 234. The collar 262 produces a stop against which the return spring 260 abuts and keeps the spring 260 straight during its compression. The plunger shaft 250 may include an integral stop rather than the separate collar 262. As the clinician moves the grip 230 in the direction of the arrow 238, the spring 260 is compressed between the collar 262 and the head 206. The tip portion 252 then moves relative to the alignment member 212. When the clinician releases the grip 230, the compressed spring 260 returns to its original configuration and drives the plunger 234 and grip 230 in the direction of the arrow 248 in FIG. 10 to a retracted position. The spring 260 maintains the plunger 234 in a retracted position until the grip 230 is pressed again.

Although not shown, the through-bore 216 of the head 206 may be sized and shaped to closely conform to the size and shape of the plunger 234, such as at least the tip portion 252. Thus, during operation of the plunger mechanism 210, the configuration of the through-bore 216 allows the plunger 234 to move relative to the head 206 along the operational axis 246 but prevents rotation of the plunger 234 relative to the head 206 and handle 202 around the axis 204. Advantageously, the plunger 234 may consistently engage the orthodontic bracket while an archwire is held in place with the alignment member 212.

With reference to FIGS. 8 and 8A, the alignment member 212 may be integrally formed in the head 206. In the embodiment shown, the alignment member 212 includes a pair of spaced apart tines 264a, 264b, which function much like the tines 144a, 144b described above with respect to the tool 100 shown in FIG. 2. However, the tines 264a, 264b may have an L-shaped configuration in which an end 266a, 266b, respectively, of each generally extends in a direction that is transverse to the operational axis 246. By way of example only and not limitation, the ends 266a, 266b of the tines 264a, 264b may be oriented generally perpendicular to the operational axis 246. By way of example only, and without limitation, the ends 266a, 266b of the tines 264a, 264b may be substantially perpendicular (i.e., within ±5° of) 90° to the operational axis 246 along their length. It will be appreciated that other orientations between the tines 264a, 264b and the operational axis 246 are possible. The relative orientation depends at least upon the orthodontic bracket and its location on the lingual surface of the patient's tooth. The ends 266a, 266b of the tines 264a, 264b may be non-orthogonally oriented to both the axis 246 and/or the axis 204. The length of the ends 266a, 266b may be sufficient to provide clearance between the remaining portion of the head 206 and the ligating slide 14 when the ligating slide 14 is in the opened position and the plunger 234 is in the retracted position.

As shown in FIGS. 8 and 8A, the tines 264a and 264b are spaced lingually over the self-ligating orthodontic bracket 10 during use of the tool 200. The ends 266a, 266b of tines 264a, 264b are sized to fit within the gap 42 (FIG. 1) between adjacent brackets on the patient's lower anterior teeth. However, the tines 264a and 264b may gradually taper in width dimension from the ends 266a, 266b to the cap portion 274 of the head 206. In that regard, the spacing between the tines 264a and 264b varies because, unlike the tines 144a and 144b of the tool 100, it is not necessary for the spacing between the tines 264a and 264b to receive the ligating slide 14. Advantageously, the tines 264a and 264b may be thicker at or near the cap portion 274 and remain rigid during application of the force necessary to maintain the archwire in the archwire slot.

Each tine 264a and 264b tapers from its location at the cap portion 274 to the ends 266a, 266b at which each tine 264a and 264b is generally configured to engage the archwire 18. To that end, each end 266a, 266b includes a forked end 268a, 268b that may engage a rectangular archwire (e.g., a square archwire) so that the clinician may apply torque to the archwire 18 by manipulating the handle 102. By way of example only, the forked ends 268a, 268b may be defined by an open-ended cutout 270a, 270b. In the exemplary embodiment, three flats 280a, 280b, and 280c (shown best in FIG. 8A) that intersect at corners define the exemplary cutout 270a, 270b. While not being limited to the configuration shown, the cutouts 270a, 270b may have a square or rectangular configuration. This wrench-like configuration may engage the archwire 18 so that one or more of the flats 280a, 280b, and 280c may be proximate one of the sides of the archwire 18.

The clinician may then rotate the tool 200 about the contact point between the cutouts 270a, 270b and the archwire 18 (as indicated by arrows 276 in FIG. 12) to apply torque to the archwire 18, if necessary. Rotating the tool 200 may cause one or more of the flats 280a, 280b, and 280c of one or both forked ends 268a and 268b to engage a flat on a rectangular archwire. The engagement between the flats 280a, 280b, and 280c and flats on the rectangular archwire 18 allows the clinician to rotate a portion of the archwire 18 about its longitudinal axis to create an active couple, essentially twisting a localized region of the archwire 18 so that the localized region fits within the archwire slot 16. By way of example only, the cutouts 270a, 270b may be sized to receive a square archwire of various sizes, for example, an archwire measuring about 0.016 inch square or one measuring 0.018 inch square, where “about” refers to within normal machining tolerances. As shown, a square archwire may fit diagonally between opposing flats 280a and 280c. The cutouts 270a, 270b may still engage the archwire 18 during rotation of the tool 200 according to arrow 276. The head 206 including tines 264a and 264b may be removed and replaced with a new head having a different tine orientation. Advantageously, removable heads may make having numerous individual tools unnecessary and may permit the clinician to select a head design for use on upper anterior teeth and another head design for use on lower anterior teeth. Different head designs may include variations in the relative angles between the tines and the operational axis to more closely match the orientation of the archwire slot. The clinician can then select a different head based on the tooth orientation (i.e., archwire slot orientation). Different ranges of torque may be applied, as is described above, to an archwire based on its location. Alternatively, a clinician may use a separate tool (not shown) to torque the archwire while the clinician uses the tool 200 to guide the archwire 18 into the archwire slot 16 and move the ligating slide 14 to its closed position. Although not shown, the forked ends 268a and 268b may engage a round archwire and facilitate placement of the round archwire in the archwire slot 16.

In addition to applying torque to a rectangular archwire, the clinician may also or alternatively forcibly seat the archwire 18 within the archwire slot 16 (as indicated by arrowed 278 in FIGS. 12 and 13). This may include forcing the archwire 18 against one or more of the surfaces 36, 38, 40 of the archwire slot 16. This is generally indicated by the arrow 278 in FIGS. 12 and 13. Advantageously, the force direction, as indicated by arrow 278, may be mainly toward a plane of the pad 34 and so acts in a direction that does not primarily produce a shear stress on adhesive (not shown) that holds the bracket 10 on the tooth. That is, the force direction is primarily toward the tooth. With the archwire 18 properly torqued and seated within the archwire slot 16, the clinician may then operate the plunger mechanism 210 to close the ligating slide 14.

To that end and with reference to FIGS. 12 and 13, the clinician operates the plunger mechanism 210 to engage the tip portion 252 of the shaft 250 with the ligating slide 14. As the clinician presses the plunger mechanism 210, such as with their finger or thumb, the clinician moves the plunger 234 from a retracted position shown in FIG. 12 toward the ligating slide 14. Further movement causes the depression 254 to engage the ligating slide 14 and the clinician is able to push the ligating slide 14 in the direction generally indicated by arrow 272 in FIG. 12 toward the closed position. The plunger 234 travels along the axis 246 and the ligating slide 14 is pushed in a similar direction. Movement of the ligating slide 14 does not necessarily coincide with the axis 246. The force applied to the plunger mechanism 210 may be sufficient to overcome any bias associated with a resilient member 20 (shown in FIGS. 12 and 13) and thus moves the ligating slide 14 to its closed position (shown in FIG. 13). Once in the closed position, the ligating slide 14 captures the archwire 18 in the archwire slot 16. Advantageously, the clinician may operate the tool 200 with one hand to rotate and seat the archwire 18 in the archwire slot 16 and then move the ligating slide 14 to the closed position.

While the present invention has been illustrated by a description of various embodiments and while these embodiments have been described in some detail, it is not the intention of the inventors to restrict or in any way limit the scope of the appended claims to such detail. Thus, additional advantages and modifications will readily appear to those of ordinary skill in the art. The various features of the invention may be used alone or in any combination depending on the needs and preferences of the user.

What is claimed is:

1. A tool to insert an archwire into an archwire slot of a self-ligating orthodontic bracket comprising:
a handle; and
a plunger mechanism operably coupled to the handle and including a plunger that is movable relative to the handle along an operational axis from a retracted position to an extended position.

2. The tool of claim 1 further including:
an alignment member proximate the plunger mechanism for holding the archwire in the archwire slot.

3. The tool of claim 2 wherein the alignment member extends in a direction that is substantially parallel to the operational axis.

4. The tool of claim 2 wherein at least a portion of the alignment member is oriented toward the operational axis.

5. The tool of claim 2 wherein the alignment member includes a pair of tines, each tine including a forked end for manipulating the archwire.

6. The tool of claim 5 wherein the forked end is an open-ended cutout with at least three flats.

7. The tool of claim 1 wherein the plunger includes a tip portion that engages a portion of the self-ligating orthodontic bracket when the plunger is moved toward the extended position.

8. The tool of claim 7 wherein the tip portion includes a recess.

9. The tool of claim 1 wherein the plunger mechanism includes a return spring that is operable to bias the plunger toward the retracted position when compressed.

10. The tool of claim 1 further including:
a head operably coupled to one end of the handle.

11. The tool of claim 10 wherein the head houses the plunger mechanism.

12. The tool of claim 10 wherein the handle includes a bore that encloses at least part of the plunger mechanism and the head closes off the bore.

13. The tool of claim 12 wherein the head includes a through-bore which receives at least part of the plunger.

14. The tool of claim 10 wherein the head includes an axial bore that receives the handle and a pair of guide bores that receive the plunger and define the operational axis.

15. The tool of claim 14 wherein the plunger mechanism further includes a stop that is coupled to the plunger in the axial bore.

16. The tool of claim 1 wherein the handle is an elongate shaft that defines an axis and the operational axis is parallel to the axis of the handle.

17. The tool of claim 1 wherein the handle is an elongate shaft that defines an axis and the operational axis is orthogonal to the axis of the handle.

18. The tool of claim 1 wherein the handle is an elongate shaft that defines an axis and the operational axis is oriented non-orthogonally to the axis of the handle.

19. A method of inserting an archwire into an archwire slot of a self-ligating orthodontic bracket attached to a tooth using a tool, the method comprising:
forcing the archwire into the archwire slot with the tool, and
simultaneously with forcing, moving a movable member of the self-ligating orthodontic bracket from an open position to a closed position with the tool to capture the archwire in the archwire slot.

20. The method of claim 19 further including torquing the archwire with the tool about its longitudinal axis while forcing the archwire into the archwire slot.

21. The method of claim 19 wherein the self-ligating orthodontic bracket is located on a lingual surface of the tooth.
